(19) United States
(12) Patent Application Publication
(10) Pub. No.: US 2014/0131393 A1
(43) Pub. Date: May 15, 2014

(54) CONTAINER FOR STORING AND DISPENSING A FLOWABLE MATERIAL

(71) Applicant: DENTSPLY International Inc., York, PA (US)

(72) Inventor: James Ronald SIRKIS, Milford, DE (US)

(73) Assignee: DENTSPLY International Inc., York, PA (US)

(21) Appl. No.: 14/159,682

(22) Filed: Jan. 21, 2014

Related U.S. Application Data
(63) Continuation of application No. 13/492,949, filed on Jun. 11, 2012, now abandoned.
Application No. 13/492,949 is a continuation of application No. 12/589,576, filed on Oct. 26, 2009, now abandoned.
(60) Provisional application No. 61/197,194, filed on Oct. 24, 2008.

(51) Int. Cl. A61C 5/06

(52) U.S. Cl. CPC A61C 5/062
USPC 222/386

(57) ABSTRACT

A package (10) for storing and dispensing a flowable material includes a container body (11) having an inlet end (20) and an outlet end (21). The container body (11) is configured to hold a quantity of the material and has a piston (30) receivable within the inlet end (20) and movable within the container body (11, 12). At least a portion of the piston (30) is selectively permeable to a selected medium.

This application claims priority to U.S. non-provisional application Ser. No. 13/492,949 filed Jun. 11, 2012, which claims priority to U.S. non-provisional application Ser. No. 12/589,576 filed Oct. 26, 2009 (now abandoned), which claims priority to U.S. provisional application No. 61/197,194 filed Oct. 24, 2008.

### TECHNICAL FIELD

The present invention is a container for the storage and dispensing of a flowable material. More particularly, the invention is such a package having an inlet end, an applicator or dispensing end and a movable piston or plug therein. The piston is at least partially transmissive of at least one medium such as air, water, contaminant or other component.

### BACKGROUND OF THE INVENTION

Containers or packages for the storing and dispensing of flowable materials are known in many arts. By “flowable” or similar words used herein it is meant any material that can be expressed by being directed toward or physically pushed toward a discharge end of a container. The material may have low viscosity like water or high viscosity resistant to flow. In the latter case, application of heat, vibration or other energy is often required to affect a flow of the material. All such materials are useful within the concepts of the present invention.

For example, U.S. Pat. No. 5,707,234 shows a container in the form of a cartridge that is particularly suited for use with dental materials. The cartridge has a container body or capsule, an outlet end or discharge nipple and an inlet end. After the material is placed within the container body normally through the inlet end, a piston or plug closes the inlet end. The piston is movable within the container body such that as a mechanical force is applied to the piston, it moves toward the discharge end. The material is thus caused to move toward the outlet end to be dispensed.

It has been found that in some cases when such a container is filled and the plug is inserted, not all of the air is removed from between the plug and the container's fill level. This trapped air in the package has a spring like quality. That is, as the plug is advanced during expression of the product the air compresses and when the plug stops moving the air expands causing more material to express from the container. This action has the undesired effect of causing the end user to get inconsistent expression of material; i.e., material continues to flow when the user wants it to stop flowing. This concept of undesired and unwanted flow of material out of the nozzle is called ooze.

Ooze prevents precise application of the contained product or material and is unacceptable to the end user. Additionally trapped air in a package can cause leakage of product due to pressure differentials between the contents and the surrounding environment during storage and transportation. Air trapped in the package may mix with the product during expression of the material and produce voids in the product, possibly compromising the quality of the end result.

A need exists therefore for a storage and dispensing package that has the useful storage and dispensing qualities of a container such as in the '234 patent, but which is able to self-vent and compensate for air trapped within the container during the filling or other procedures.

### SUMMARY OF THE INVENTION

In general, a package for storing and dispensing a flowable material comprises a container body having an inlet end and an outlet end. The container body is configured to hold a quantity of the material and has a piston receivable within the inlet end and movable within the container body. At least a portion of the piston is selectively permeable to a selected medium.

### BRIEF DESCRIPTION OF THE DRAWINGS

FIG. 1 is a side elevation, sectional view of a package according to the concepts of the present invention.

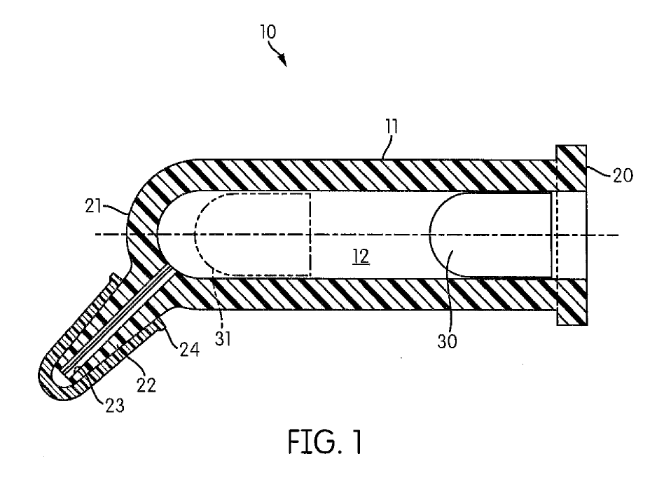

### PREFERRED EMBODIMENTS FOR CARRYING OUT THE INVENTION

A package for the storage and dispensing of a flowable material according to the concepts of the present invention is generally designated by the number 10 on the attached drawing. Package 10 has a container body 11 configured to have an open area or cavity 12 therein for storing a flowable material (not shown). Package 10 has an inlet end 20 and an outlet end 21. Although not necessarily a part of the present invention, one preferred package 10 has an outlet end 21 fitted with a discharge nipple 22 having a passage 23 therethrough and in fluid communication between cavity 12 and the atmosphere. Discharge nipple 22 may be fitted with a removable cap 24 to selectively close off passage 23.

A preselected quantity of flowable material (or as discussed above, a material capable of being induced to flow by any means) such as a dental adhesive or restorative is placed into cavity 12 by standard manufacturing techniques that are well known in the industrial arts, and preferably through inlet end 20. A movable piston or plug 30 is then received within inlet end 20 such that piston 30 closes off, and at least selectively seals inlet end 20. Piston 30 is moveable within cavity 12 such as is shown by phantom lines 31, and preferably in a direction toward outlet end 21. In this manner, the material (not shown) is caused to move toward outlet end 21 to be discharged therefrom, such as by passing through passage 23 and with cap 24 removed, out to the atmosphere. As alluded to above, any mechanical force may be applied to piston 30 to effect such movement. The specific means of inducing such force is well known in the art and includes for examples guns and syringes. All such means are within the scope of the invention and the particular means is not germane to the invention as long as some means is provided to move piston 30.

As discussed above, during the filling or other procedures, a quantity of air or other contaminant may be trapped within cavity 12 along with the desired material. For example, carriers such as water, alcohols or the like may be present with or even leach from the material itself and it may be desirable to remove these mediums. According to the present invention piston 30 is at least partially permeable to one or more such mediums such that the selected medium can be caused to pass through piston 30 to thereby be removed from package 10, but not permeable to the material to be dispensed. In this manner, either during the filling stage or even in use by the end user, the undesired or selected medium can be caused to flow through piston 30 and out of package 10 while the material to be dispensed is moved along by the action of piston 30 as was above described.

The specific material from which a piston 30 will be fabricated will vary according to the material itself. For example, pistons may be fabricated from silicones, epoxy, rubber, glass, ceramics, porcelains and mixtures thereof. Useful polymeric materials include for example, polyethylene (PE), polypropylene (PP), polyamines such as nylon-6, polytetrafluouroethylene (PTFE), ultra-high molecular weight polyethylene (UHMWPE), high-density Polyethylene (HDPE), polyvinylidene fluoride (PVDF), ethyl vinyl acetate (EVA), thermoplastic polyurethane (TPU), polyester (PET), low-density polyethylene (LDPE) and mixtures thereof. Piston 30 may be fabricated from a pliable material, a resilient material, a soft or even a hard material, again based upon the specific needs of a given material to be stored and dispensed. A woven fabric or mesh, crystals, tubes, granules, irregular shaped materials and the like are within the scope of the invention. In a preferred embodiment, piston 30 will provide a seal between the outside atmosphere and the material stored within cavity 12.

It is also within the scope of the invention to provide a piston 30 fabricated from a single material of selected porosity or to fabricate a piston 30 having only a portion or selected portions permeable by or porous to a selected or indeed a plurality of selected mediums. For example, one portion of piston 30 may be fabricated from a stronger material for strength or a pliable material for its sealing effect, while one or more other portions are porous to or permeable by the selected medium or mediums. A piston 30 having one portion permeable by air, another permeable by water yet no portion permeable by the material to be stored or dispensed is an example. It is also within the scope of the invention to provide a piston 30 that is selectively permeable to a medium at a given rate. For example, in certain applications a piston 30 may be permeable to a selected medium but only over time. By properly selecting the material from which to fabricate such a piston 30, its pore sizes, shapes or the like, the medium can be caused to permeate piston 30 at a preselected rate.

It is also within the scope of the invention to provide for other components in the alternative to or in addition to the piston which likewise are permeable to the selected medium, such as cap 24 for example. The invention has been described with respect to the piston 30 being the means by which selected porosity or permeability to a medium is achieved, but that is a preferred embodiment only. Other components of package 10 may be so configured. Similarly, the invention has been described herein for exemplary purposes as being useful for the removal or egress of a medium from package 10. It is equally within the scope of the invention to provide a package 10 as described herein that permits the ingress of a medium into cavity 10. All such configurations are within the scope of the present invention.

It is evident therefore that package as described herein provides an advantageous contribution to the art. The invention has been described and shown on the drawings for exemplary purposes only and without attempting to show each and every variation within the scope thereof. The scope of the invention shall only be determined by any attached claims.

What is claimed is:

1. A package for storing and dispensing a flowable material comprising a container body having an inlet end and an outlet end, said container body configured to hold a quantity of the material, and having a piston receivable within said inlet end and movable within said container body; at least a portion of said piston being selectively permeable to a selected medium.

2. A package as in claim 1 wherein said piston is at least partially permeable to water.

3. A package as in claim 1 wherein said piston is at least partially permeable to air.

4. A package as in claim 3 wherein said piston is porous to air but not to the flowable material.

5. A package as in claim 1 wherein said piston is fabricated from a material selected from the group consisting of polyethylene (PE), polypropylene (PP), polyamines, polytetrafluouroethylene (PTFE), ultra-high molecular weight polyethylene (UHMWPE), high-density Polyethylene (HDPE), polyvinylidene fluoride (PVDF), ethyl vinyl acetate (EVA), thermoplastic polyurethane (TPU), polyester (PET), low-density polyethylene (LDPE) and mixtures thereof.

6. A package as in claim 1 wherein said piston is fabricated from a material selected from the group consisting of silicones, epoxy, rubber, glass, ceramics, porcelains and mixtures thereof.

7. A package as in claim 1 wherein said piston is a woven fabric.
